(19) United States
(12) Patent Application Publication
(10) Pub. No.: US 2023/0023121 A1
(43) Pub. Date: Jan. 26, 2023

(54) APPLICATION BENCHMARK USING EMPIRICAL HARDNESS MODELS

(71) Applicant: Zapata Computing, Inc., Boston, MA (US)

(72) Inventor: Yudong Cao, Cambridge, MA (US)

(21) Appl. No.: 17/848,301

(22) Filed: Jun. 23, 2022

Related U.S. Application Data
(60) Provisional application No. 63/214,062, filed on Jun. 23, 2021.

(51) Int. Cl. G06N 10/60; G06N 20/00; G06K 9/62

(52) U.S. Cl. CPC G06N 10/60; G06N 20/00; G06K 9/6256

(57) ABSTRACT

A method and system are provided for modeling the relative performance of algorithms, including quantum algorithms, over a set of problem instances. The model, referred to as a performance estimator, is generated from a selected algorithm and a set a set of problem instances as input, resulting in a generated model. Unlike prior methods, which model the performance of a fixed algorithm on a set of instances, embodiments of the present technology produce a performance estimate without needing to explicitly model the underlying algorithm. The model, once generated by the disclosed technology, may then be utilized to estimate the performance of new algorithms that the model has not been trained on.

### BACKGROUND

### Field of the Technology Disclosed

The disclosed technology relates to a method and system for modeling the relative performance of algorithms, including quantum algorithms, over a set of problem instances using empirical hardness models, without needing to explicitly compute the underlying algorithms.

### Description of Related Art

The subject matter discussed in this section should not be assumed to be prior art merely as a result of its mention in this section. Similarly, any problems or shortcomings mentioned in this section or associated with the subject matter provided as background should not be assumed to have been previously recognized in the prior art. The subject matter in this section merely represents different approaches, which in and of themselves can also correspond to implementations of the claimed technology.

Quantum computers promise to solve industry-critical problems which are otherwise unsolvable or only very inefficiently addressable using classical computers. Key application areas include chemistry and materials, bioscience and bioinformatics, logistics, and finance. Interest in quantum computing has recently surged, in part due to a wave of advances in the performance of ready-to-use quantum computers.

Many enterprises deeply rely on the execution of heavy computational workflows to carry out their business operations. Also, almost every commercial research and development team relies heavily on computation to augment their activities. At the heart of these workflows are algorithms which are often heuristic in nature, where the expected performance is obtained only through empirical analysis. Making the most of computational resources—including both accuracy, time-to-solution, and cost—requires the selection of the best algorithm for the task at hand.

The comparison of different algorithms is a difficult and time-consuming exercise. Performance guarantees do not exist for heuristic algorithms, and their success may depend heavily on the instances of the problems that they solve. Existing methods only model an expected performance metric for a fixed algorithm given a data set. It has been demonstrated that empirical runtimes of identically-sized problem instances may vary by orders of magnitude. The disclosed technology overcomes these drawbacks in algorithm runtime prediction methods.

### SUMMARY

The problem of algorithm runtime prediction is addressed by the disclosed technology using empirical hardness models. An empirical hardness model is a supervised machine learning method, which may be described in general terms as a model that determines the performance of an algorithm, based on a set of performance criteria. The factors that contribute to an empirical hardness model are the time spent by an algorithm searching for a solution, the quality of an optimal solution, and the gap between found and optimal solutions.

As previously stated, it has been demonstrated that empirical runtimes of identically-sized problem instances may vary by orders of magnitude. Empirical hardness models use machine learning to build models of an algorithm for a set of problem instances. The empirical hardness model is then used to predict the algorithm runtime for problem instances. Multiple algorithms may be modeled to generate a performance identifier for a set of problem instances, and sampling may provide more reliable benchmark distributions.

The modeling process for an empirical hardness model starts with mapping a set of features that describe a problem instance to a real value representing the modeled algorithm's predicted runtime. Feature selection is important to constructing a model. Runtimes can increase exponentially as the problem size increases. Empirical hardness models can provide insight into the factors responsible for an algorithm's performance, or to induce distributions of problem instances that are challenging for a given algorithm. They can also be leveraged to select among several different algorithms for solving a given problem instance. Empirical hardness models have also proven very useful for combinatorial optimization problems, such as the traveling salesperson problem.

The method of generating an empirical hardness model starts with defining a set of features for individual problem instances that may correlate with an algorithm's performance. Samples are drawn from the data distribution, which are then used as training data related to runtime. Supervised machine learning methods use the collected training data to train the empirical hardness model. In the case of a new problem, the characteristics of the problem instance are input into the model, resulting in a runtime prediction for that instance. In other words, supervised machine learning methods are used to build models that reliably predict an algorithm's runtime for a given problem instance.

The disclosed technology may be used to predict the runtime of algorithms which have not been previously modeled. Very accurate models of algorithm's runtimes may be generated and benchmarked which will be applicable to harder problem instances.

Embodiments of the present invention are directed to a method for modeling the relative performance of algorithms over a set of problem instances. Such a model, herein referred to as a performance estimator, takes an algorithm and a set of problem instances as input and returns a model. Unlike prior methods, which can model the performance of a fixed algorithm on a set of instances, embodiments of the present invention may produce a performance estimate without needing to explicitly model the underlying algorithm. The model, once produced by the present invention, may then be utilized to estimate the performance of newly introduced algorithms that the model has not been trained on.

In one aspect of the disclosed technology, a method is provided for modeling the relative performance of algorithms over a set of problem instances. The method may be implemented on a classical computer, a quantum computer, or a hybrid quantum-classical computer. The classical computer includes a processor, a non-transitory computer-readable medium, and computer instructions stored in the non-transitory computer-readable medium. The quantum computer includes a quantum component, having a plurality of qubits, which accepts a sequence of instructions to evolve a quantum state based on a series of quantum gates. The computer instructions, executed by the processor, perform in one embodiment, a method of generating a model that predicts the performance of an algorithm for an application instance without actually running the algorithm, wherein the model is generated by defining a set of features for individual application instances; using unsupervised learning to train a machine learning model; encoding the algorithm in the set of features; applying training data, to thus generate an algorithm-agnostic model.

In another aspect, the encoded features of the algorithm may include hyper-parameters. Also, the method may provide an indicator of the performance of the algorithm on representative problem instances.

In another aspect, a 1D Fermi-Hubbard model may be used as an application benchmark for gauging the ability of the algorithm to handle strongly correlated fermionic problems. The disclosed technology may be used for benchmarking the runtime of a given algorithm.

In another aspect, the given algorithm is a quantum algorithm. The set of features is used for training and accurate empirical hardness model for specific quantum algorithms. Feature selection relies on specific knowledge of application domains, which have very specific requirements. In another aspect, the application domain is an aerospace application. The application domain may also be a quantum cryptographic application. In a further embodiment, the application domain may be a transportation application. In another aspect, the application domain may be an advanced manufacturing application. In another application domain, the application may be a financial services application. In another aspect, the application domain may the energy industry or the materials industry.

Another embodiment of the disclosed technology is for a method for generating a performance estimator model indicative of the relative performance of an algorithm over a set of problem instances. The embodiment is implemented on a hybrid quantum-classical computer. A set of problem instances is received by the hybrid quantum-classical computer. A set of features for individual problem instances are defined. Following this step, machine learning is used to train an empirical hardness model using the set of features, without running the algorithm. In one aspect, the method provides a performance estimate for algorithm runtime.

The algorithm may be a quantum algorithm. The performance estimator takes an algorithm and a set of problem instances and returns a performance model. Using the disclosed technology, the performance estimate for an algorithm may be determined for an algorithm which has not been explicitly modeled. Also, the performance estimator may be used for generating a performance estimate for a non-benchmarked algorithm. In a further aspect, the performance estimator may be used for estimating the performance of new algorithms that have not been modeled or trained on.

In another embodiment of the disclosed technology, a hybrid quantum-class computer system is provided for modeling the relative performance of algorithms for a set of problem instances, the computer system comprising a classical computer and a quantum computer. The classical computer includes a processor, a non-transitory computer-readable medium, and computer instructions stored in the non-transitory computer-readable medium. The quantum computer includes a quantum component, having a plurality of qubits, which accepts a sequence of instructions to evolve a quantum state based on a series of quantum gates.

Computer instructions, when executed by the processor, perform a method for generating on the hybrid quantum-classical computer a model for benchmarking the relative performance of an algorithm over a set of problem instances. The system implements the method of generating a model M_{A} that predicts the performance y of an algorithm A on an application instance without running the algorithm A. The disclosed technology defines a set of features \vec{v} for describing individual application instances p. Using supervised learning, a model M_{A} is generated, such that y_{i,A}≈M_{A}(\vec{v}). An algorithm A is encoded in a set of features \vec{u}. Training data is applied, and an algorithm-agnostic model M is generated, such that y_{i,A}≈M(\vec{v}_{I}, \vec{u}_{A}), wherein the model is a performance estimator for predicting the runtime of an algorithm.

In another aspect of the disclosed system, the algorithm may be a quantum algorithm. Also, the performance estimator may estimate the performance of new algorithms that have not been modeled or trained on. In addition, the performance may be estimated for an algorithm which has not been explicitly modeled. Also, the performance estimator may generate a performance estimate for a non-benchmarked algorithm.

### BRIEF DESCRIPTION OF THE DRAWINGS

The disclosed technology, as well as a preferred mode of use and further objectives and advantages thereof, will best be understood by reference to the following detailed description of illustrative embodiments when read in conjunction with the accompanying drawings. In the drawings, like reference characters generally refer to like parts throughout the different views. The drawings are not necessarily to scale, with an emphasis instead generally being placed upon illustrating the principles of the technology disclosed.

FIG. 1 is a diagram of a quantum computer according to one embodiment of the present invention;

FIG. 2A is a flowchart of a method performed by the quantum computer of FIG. 1 according to one embodiment of the present invention;

FIG. 2B is a diagram of a hybrid quantum-classical computer which performs quantum annealing according to one embodiment of the present invention; and

FIG. 3 is a diagram of a hybrid quantum-classical computer according to one embodiment of the present invention.

FIG. 4 is a flowchart illustrating a method for generating a performance estimator model, according to the disclosed technology;

FIG. 5 illustrates the framework in which the disclosed system and method operate, showing a list of technical subjects and core enabling computational capabilities, which are intended to be exemplary and not exhaustive;

FIG. 6 illustrates the disclosed method for measuring C(y) as part of utility impact assessment; and

FIG. 7 is a graphic illustration showing possible scenarios resulting from the cost estimation as a function of performance, wherein the slope of C(y) is indicative of whether quantum advantage is likely for this instance group.

### DETAILED DESCRIPTION

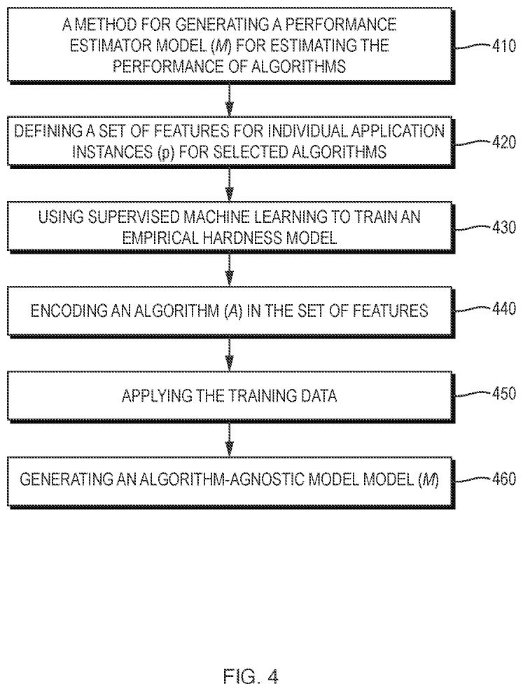

Turning initially to FIG. 4, a flowchart is shown for a method for generating a performance estimator model M, using empirical hardness models. Initially, in step 410, the method for generating a performance estimator model M is initiated. In step 420, a set of features for individual problem instances p for a selected algorithm is defined. In step 430, an empirical hardness model is generated using supervised machine learning and training data. Once the model is generated, a new algorithm A is encoded in the set of features. Following this step, in step 450, training data is applied to the model. As a result of training, and algorithm-agnostic model M is generated.

### Definitions

Initially, specific terminology requires definition to appreciate the disclosed technology. The following terms are defined: problem instance, application instance, candidate metric, utility threshold, and utility estimate.

A problem instance is the specification of a computational problem that contains all the information needed for carrying out hardware-specific resource estimation. This definition is distinct from an application instance, which contains information deemed sufficient for a domain expert to implement a (quantum or classical) solution to the problem defined by a problem instance. A problem instance contains additional information that a quantum computing expert would need to implement a quantum solution.

For example, in the case of molecular electronic structure calculations, an application instance includes information such as molecular geometry and basis sets, while a problem instance goes further and defines the Hamiltonian mapping approach, including whether it is first-quantization or second quantization, and if it is second quantization, which fermion-spin mapping is needed, including the circuit ansatz choice and the strategy for initializing and optimizing the ansatz parameters, among others.

A use case is a complete computational solution in an application domain for achieving a business/organizational goal, such as designing the optimal logistic processes.

A technical subject is a well-defined technical task that underlies a use case in an application domain. For example, a financial portfolio optimization use case may involve combinatorial optimization of the portfolio, while the objective function of the optimization problem may be a risk measure that requires Monte Carlo simulations to evaluate. In this case, the use case may be decomposed into two technical subjects: mathematical optimization of the portfolio, and Monte Carlo simulation for computing the objective function.

The disclosed technology centers around the concept of quantum advantage, in which a quantum computer surpasses the capability of a classical computer. The related term quantum supremacy pertains to the concept of quantum advantage in a purely mathematical sense. In a more practical sense, certain embodiments of the disclosed technology produce an application instance where a quantum computer contributes critically to solving a practically valuable problem that is previously intractable, to an extent that brings quantifiable and significant commercial value to an end user. The demand that a quantum computer contributes “critically” is meant to exclude scenarios where a classical algorithm is advancing the state of the art, while a quantum computer is, in a sense, along for the ride. The term practically valuable is opposed to application instances in mathematically interesting application domains with little or no quantifiable utility. The term previously intractable to meet the utility threshold for the application instance requires an amount of computational resource that is beyond what is reasonably feasible with classical computing. The term quantifiable and significant commercial value encompasses the concept that a clear dollar amount may be attached to meeting the utility threshold. In other words, the utility impact is clearly quantifiable.

As may be deduced from the above discussion, a more general term utility metrics may encompass the separate concepts of candidate metric, utility threshold, and utility estimate. For some problems, such as ground states of Fermi-Hubbard models, it is uncertain whether these concepts are practically valuable. Much work is needed to derive use from their solutions for solving problems in practical applications such as materials simulation. However, these problems are certainly important milestones towards something that is unambiguously practically valuable. We call these milestone problems practically relevant.

Solving previously intractable problem instances on quantum devices is the goal of every researcher working in quantum computing. However, in practice, enterprises may care only about beating the performance of their legacy algorithms. There are well-known candidate problems that give rise to intractable instances. However, a larger set of problems are those that are difficult for most commonly used classical algorithms in practice by the industry, without undue fine-tuning for optimization. For example, the CPLEX optimizer is not optimal in all instances where it is used. However, by carefully choosing the initial parameters of the algorithm, i.e., undue fine-tuning, these off-the-shelf algorithms perform significantly better. This larger set of problems are called probably improvable.

There are known problems for which the business impact is relatively easy to quantify. For example, solving the Traveling Salesperson Problem produces better and shorter routes, which translates directly into reduced business costs. But solving other challenging problems may open new possibilities not previously considered. For example, the business impact of being able to accurately predict the binding energy between drug molecules and targets opens possibilities of creating new drugs. In these scenarios, quantum computers bring unquantifiable yet significant commercial value.

There are two classes of individuals in technical organizations and enterprises, who have a direct effect on the creation of problem instances. These individuals have a different perspective on how problem instances are defined and classified. Being able to manage the interaction with both classes of individuals is an important factor to successful application instance discovery.

A domain stakeholder is a person who is in a position to make go/no-go decisions on the technical directions of a team or organization. These decisions may have budgetary implications and long-term business impact. A domain stakeholder may be a CIO, a CTO, a director of research, a director of innovation, or cross-functional team managers for specific technical initiatives. A domain stakeholder needs to be informed by domain specialists.

A domain specialist is a person who operates as an individual contributor on a technical team in an organization. The domain specialist possesses detailed working knowledge of various computer methods, either quantum or classical, which address specific application instances including the trade-offs between different methods. This domain specialist may report directly or indirectly to a domain stakeholder. The domain specialist in an organization may have a functional such as a computational chemist, an operations research expert, a quantitative finance specialist, or an algorithm engineer.

### Identifying Quantum Application Instances

R&D in today's enterprises is typically executed by teams of domain stakeholders (CIOs, directors, and managers) who rely on domain specialists (scientists, engineers and consultants) for detailed perspectives on a potential technology. Identifying high-value application instances results from combining the perspectives of individual technical contributors with the wider perspectives of application domains provided by the domain stakeholders.

For some application instances, such as those requiring Monte Carlo simulation or other forms of statistical sampling as core computational capabilities, rigorous mathematical arguments may be made about the fundamental limitation of classical solutions and the advantage due to quantum computing. Other application instances may involve particular instances of NP-hard problems or in the case of quantum simulation, QMA-hard problems. This essentially compares heuristic algorithms in both quantum and classical cases, and rigorous analysis may not be practical. The distinction between these two scenarios informs the approach to the application.

The disclosed technology provides a method for measuring utility metrics that not only builds on prior approaches, but also adds significant innovations in empirical hardness from computer science. This approach provides a framework for addressing a lack of rigor in regard to heuristic algorithms. For example, in combinatorial optimization, many problems are proven NP-hard in the worst case (at least as hard as the hardest problems in (NP) Non-Deterministic Polynomial Time), but the hardness of instances of those problems in industry applications requires a different concept of hardness, namely “empirical hardness.” The disclosed technology extends some existing methods for empirical hardness and proposes a machine learning approach for measuring utility metrics. The disclosed technology further envisions a quantum benchmarking testbed as part of the testing procedure.

### Choosing Application Domains

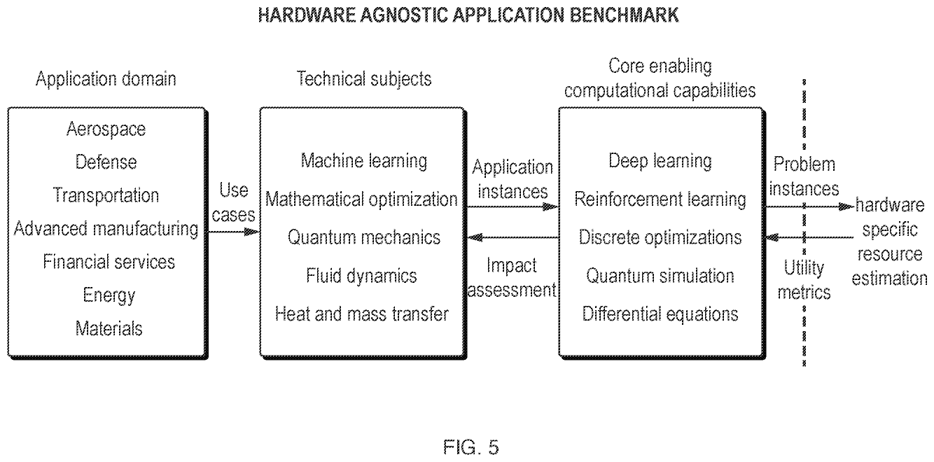

A rationale that may be used for choosing the application domains in certain embodiments of the present invention is discussed in what follows. This will be followed by a discussion of a method for generating application instances and a method for measuring utility metrics in application instances. FIG. 5 shows seven application domains, including aerospace, defense, transportation, advanced manufacturing, finance, energy, and materials. These application domains are considered high impact domains with transformational utility in government and commercial realms. The disclosed methods may be applied, for example, to one or more of these application domains. The list of technical subjects and core enabling computational capabilities are not exhaustive or final. They serve as examples to convey the conceptual framework outlined herein.

Aerospace Domain—Many applications in the aerospace industry require large computational resources for simulating the complex engineering systems governed by hard-to-solve differential equations and will benefit by using quantum computer methods. Problems related to Schrodinger equation, for example, have been solved exponentially faster than with classical computers. In a similar manner, quantum computers may be used to simulate use cases that arise in aerospace industry.

Defense Domain—Outside the cryptographic implications of quantum computers, the need for optimizing logistics for effectively deploying capabilities also poses serious computational challenges. Quantum-enhanced optimization techniques present valuable opportunities to address those challenges.

Transportation Domain—Some corporations combine satellite, unmanned aerial systems (UAS), and LiDAR data with big data analytics to improve safety, reduce expenses, and make better decisions. These complex needs require enhanced capabilities for data science and machine learning, including quantum machine learning.

Advanced Manufacturing Domain—In advanced manufacturing, the electro-mechanical systems that companies provide for aviation and maritime applications require optimization for process scheduling, fault diagnosis, logistics optimization, and others. Quantum-enhanced optimization techniques present valuable opportunities to address those challenges.

Financial Services Domain—Financial services application are receiving benefits from quantum computing use cases. One use, for example, is leveraging quantum mechanics for accelerating Monte Carlo based simulation of stock prices, and therefore reducing the cost of computationally intensive tasks such as derivative pricing and risk analysis. Another prominent area is optimization in which quantum and quantum-inspired machine learning techniques may enhance financial use cases such as portfolio optimization.

Energy Industry Domain—The energy industry uses quantum computing in use cases such as calculating molecular electronic structure, which far outperform classical algorithms. The use of quantum computers for quantum chemistry use cases is expanding.

Materials Industry Domain—The materials industry uses quantum computing in the same way as the energy industry, by quantum simulation of materials at the atomic or molecular level. For example, computing the HOMO/LUMO gap of organic materials is a critical core computational capability for determining whether a material is suitable for Organic Light Emitting Diode (OLED) applications.

The application domains in FIG. 5, are deeply connected with the technical subjects that underlie use cases in the application domains listed above. It is anticipated that some form of quantum error correction may be needed for quantum devices to outperform classical algorithms for moderately-large problem instances, such as molecular simulation with ˜20 spin orbitals. Quantum error correction methods, coupled with the disclosed technology, may pave the path towards quantum advantage in quantum chemistry and beyond.

### Generating Application Instances

A general approach for generating application instances, which is used by certain embodiments of the present invention, is outlined in the following steps, which are based on the specific definitions provided earlier.

Initially, compile a comprehensive list of domain stakeholders that are decision makers in various technology organizations across the application domains. Solicit from each domain stakeholder a list of use cases that involve technical subjects that are within the scope.

FIG. 5 provides a tentative list, which may be adjusted based on relative commercial values of these technical subjects as well as how likely these technical subjects will give rise to meaningful application instances and problem instances down the road. Gather from the domain stakeholders a list of domain specialists that possess relevant know-how to identify application instances of interest.

Domain specialists are chosen with enough technical depth to prepare for later steps where application instances need to be generated. The domain specialists decompose the use cases into technical subjects. Solicit from domain stakeholders and/or domain specialists' assessments of technical subjects generated in step 2. A grading system is used where each use case starts with 0 point, and 2 points are added for each of the following that the use case satisfies: practically valuable, or previously intractable, or yields quantifiable and significant commercial value (see “Definition”). In addition, 1 point is added for each of the following that the use case satisfies: practically relevant, or probably improvable, or yields unquantifiable yet significant commercial value.

TABLE 1
Example of grading results for the use cases.

| | Practically | Previously | Quantifiable and significant | |
|---|---|---|---|---|
| Technical subject | valuable | intractable | commercial value | Total score |
| Generative modeling | ✓ | ✓* | ✓* | 4 |
| (unsupervised machine | | | | |
| learning) | | | | |
| Evaluating matrix | | ✓ | | 2 |
| permanent (linear algebra) | | | | |
| Fermi-Hubbard model | ✓* | ✓ | ✓* | 4 |
| (simulation) | | | | |
| Molecular electronic | ✓ | ✓ | ✓* | 5 |
| structure calculation | | | | |
| (simulation) | | | | |
| Feature selection | ✓ | | ✓* | 3 |
| (optimization / machine | | | | |
| learning) | | | | |
| Fault diagnosis | ✓* | ✓* | ✓ | 4 |
| (optimization) | | | | |
| Logistic process design | ✓ | ✓* | ✓ | 5 |
| (optimization) | | | | |

Here ✓means 2 points are assigned to this criterion, while ✓* means only 1 point is assigned (the use case is described by the more ambivalent counterpart of the column). A blank cell means this column is almost negligible for the use case.

Technical subjects are selected with a rating of 4 or more. The minimum value of 4 points ensures that each technical subject has at least one strong feature (those with ✓ in Table 1). However, the point system serves more as a guideline than a rule. Exceptions may be made for specific technical subjects. Following this step, application instances are generated from the selected technical subjects, with guidance provided by domain specialists. This ensures that the application instances are maximally relevant to practice. In the next step, mapping is performed from technical subjects to application instances, which involve various core computational capabilities. The next step is to generate problem instances from the application instances.

The process described above is a top-down approach to distill technical subjects from use cases in different application domains (the arrow going from “Application domain” to “technical subjects”). Technical subjects are mapped to application instances involving various core computational capabilities. Problem instances arising from application instances are further specified.

Problem instances may arise from the application instances. Using the top-down approach in generating the application instances, the instance groups emerge naturally because the application instances are already grouped by technical subjects. Alternatively, the application instances may be generated first and then grouped together afterward. One focus may be on quantum amplitude amplification and estimation techniques. However, not all quantum algorithms involve amplitude estimation schemes.

### Designing and Evaluating Utility Impact

The utility gained by algorithmic performance improvement is decomposed into two components:

Utility gain (in $)=Additional benefit ΔB (in $)−Additional cost ΔC (in $)

Let y be a set of performance metrics that can be directly measured. Suppose introducing a novel solution yields a new level of performance y_{new} compared with the existing solution y_{old}. Then ΔB=B(y_{new})−B(y_{old}) and ΔC=C(y_{new})−C(y_{old}), where the benefit B and cost C are both functions of performance.

The estimation of ΔB requires inputs from line-of-business personal. The estimation of ΔC requires inputs from the engineering and research team. For estimating ΔC, two cases are distinguished:

1. For quantum algorithms with rigorous mathematical arguments for quantum speedup, the cost of executing quantum algorithms C(y) as a function of performance can be computed analytically or numerically.

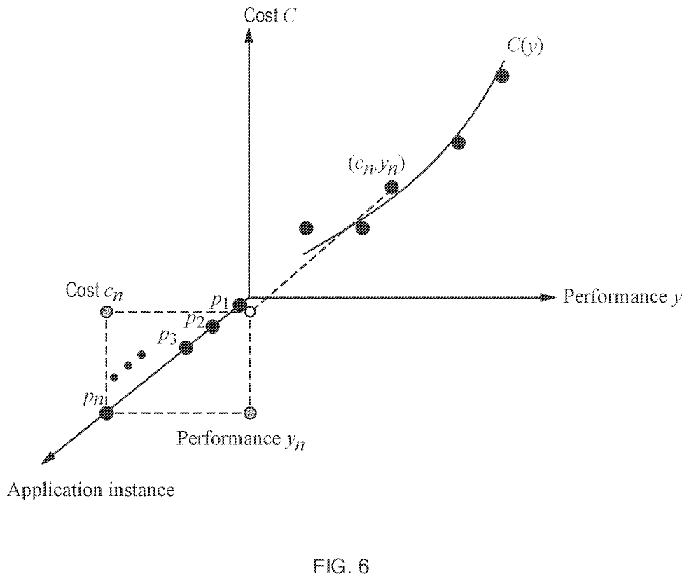

2. For quantum or classical algorithms that are heuristic, the function C(y) can be approximated through the following process. FIG. 6 illustrates the process for measuring C(y) as part of utility impact assessment.

3. For each application instance pi in an instance group, execute algorithm (quantum or classical) A and estimate performance y_{i,A} and cost c_{i,A} using the model.

4. Repeat step 1 for algorithms A₁, A₂, . . . Aₖ. Here the set of Aᵢ can be different algorithms or the same algorithm with different hyperparameters. For instance, they can be simulated annealing with different annealing schedules, or implementations of QAOA with different parameter training approaches.

5. For each application instance pᵢ, compute y_{A*,i} and c_{A*,i} where

$${A}^{*} = {arg max}_{A ∈ \{ {A}_{1} , {A}_{2} , … , {A}_{k} \}} \frac{{y}_{A , i}}{{c}_{A , i}}$$

is the algorithm that yields the most performance per unit cost. For some instances, A* may be considered the best algorithm for the application instance pᵢ. In the case where y is multi-dimensional, A* is chosen by balancing the importance of different components of y.

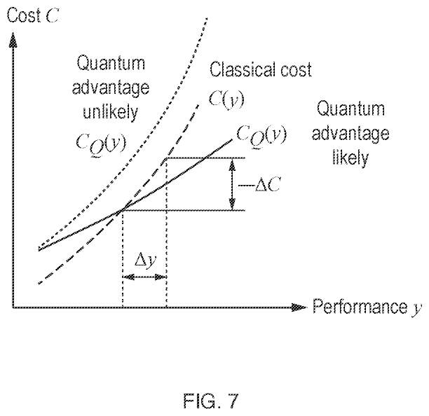

6. Fit the data set {(cᵢ, yᵢ)|i=1, . . . , n} with a functional dependency C(y). Let c_{i,Q} and y_{i,Q} be the result produced by the steps above for a set of quantum algorithms, and C_{Q}(y) be the resulting functional fit. FIG. 7 outlines several scenarios that are possible in principle in comparing quantum and classical algorithm performances. FIG. 7 illustrates possible scenarios resulting from the cost estimation as a function of performance. The overall slope of C(y) is indicative of whether quantum advantage is likely for this instance group.

### Generating an Empirical Hardness Model

It may not be feasible to execute the above steps for all application instances. To make the disclosed technology scalable, recent work in empirical hardness models may be applied. Embodiments of the present invention may construct a model M_{A} that predicts the performance y of an algorithm A on an application instance without running algorithm A. Using the data from step 1, the following method may applied:

1. Define a set of features \vec{v} for describing individual application instances p.

2. In a supervised learning setting, train a model M_{A} such that y_{i,A}≈M_{A}(\vec{v}ᵢ). Selecting the right features \vec{v} relies on domain knowledge about the application instances, and therefore requires collaboration with domain specialists. The subscript A in M_{A} emphasizes that the empirical hardness model is specific to A. To create a model which is algorithm-agnostic, we can also encode an algorithm A in a set of features \vec{u}. Then with raw training data from step 1 above, we can obtain an algorithm-agnostic model M such that y_{i,A}≈M(\vec{v}_{I}, \vec{u}_{A}). Possible entries to \vec{u}_{A} include:

1. Hyper parameters of the algorithm A.

2. Performance of the algorithm on representative problem instances. For example, one can use 1D Fermi-Hubbard model as an application benchmark for gauging the ability of the algorithm to handle strongly correlated fermionic problems.

3. Properties of the outputs of A.

### Quantum Benchmarking Testbed

A potential design of a quantum benchmarking testbed would be to supply information for item 3 above in the feature vector \vec{u}_{A} associated with a given algorithm A. For example, A may be a quantum algorithm that produces some quantum state |ψ [symbol] as its output. There can be properties such as its overlap with another state |ϕ [symbol] or the expectation of some quantum operator O that can only be efficiently measured on a quantum device. At the same time, these properties can be highly informative for training an accurate empirical hardness model M for quantum algorithms. In this case, a quantum computer may be used to estimate these properties.

One embodiment is directed to a method, performed on a computer system, for modeling the relative performance of algorithms over a set of problem instances. The computer system includes a classical processor, a non-transitory computer-readable medium, and computer instructions stored in the non-transitory computer-readable medium. The computer instructions, when executed by the classical processor, perform the method. The method may include generating a model M that, when applied to an algorithm A, predicts a performance y of the algorithm A on an problem instance p without running the algorithm A. Generating the model M may include: defining a first set of features \vec{v}ᵢ for a set of training problem instances pᵢ; encoding a set of training algorithms Aⱼ in a second set of features \vec{u}ᵢ, wherein the set of training algorithms Aⱼ does not include the algorithm A; generating a set of training data (y_{m,n}, \vec{u}ₘ, \vec{vu}ₙ) by computing a set of performance metrics y_{m,n} where y_{m,n} depends on data generated from algorithm Aₘ solving problem instance pₙ; and using supervised learning to train the model M based on the set of training data such that y_{m,n}≈M(\vec{u}ₘ, \vec{v}ₙ).

The method may further include predicting the performance y of algorithm A. The predicting may include: defining a problem feature vector \vec{v} for the problem instance p; encoding the algorithm A in an algorithm feature vector \vec{u}; and computing the performance of algorithm A according to y≈M(\vec{u}, \vec{v}), without running the algorithm A. The method may further include using the model M to predict the performance of an algorithm B. The algorithm B may be an algorithm other than the algorithm A. For example, the algorithms A and B may have different features, such that if the algorithm B is encoded in a feature vector, that feature vector is different than the in an algorithm feature vector \vec{u} in which the algorithm A is encoded.

The second set of features \vec{u}ⱼ may include hyper-parameters of the algorithm Aⱼ. The second set of features \vec{u}ⱼ may include an indicator of performance of the algorithm Aⱼ on representative problem instances. The second set of features \vec{u}ⱼ may include properties of the outputs of the algorithm Aⱼ. A benchmarking testbed may supply information for the second set of features \vec{u}ⱼ.

A 1D Fermi-Hubbard model may be used as an application benchmark for gauging an ability of the algorithm A to handle strongly correlated fermionic problems.

The computer system may further include a quantum computer. The quantum computer may include a quantum component, having a plurality of qubits, which accepts a sequence of instructions to evolve a quantum state based on a series of quantum gates. The algorithm A may be a quantum algorithm, which may execute on and/or be executable on, the quantum computer. The quantum algorithm A may produce a quantum state |ψ [symbol] as its output. The quantum state |ψ [symbol] may overlap with another quantum state |ϕ [symbol] . Defining the first set of features \vec{v}ᵢ may include using domain knowledge about the application instances, provided by domain specialists, to define the first set of features \vec{v}ᵢ.

Another embodiment is directed to a system including a non-transitory computer-readable medium having computer instructions stored thereon. The computer instructions may be executable by a classical processor to perform a method for modeling the relative performance of algorithms over a set of problem instances. The method may include generating a model M that, when applied to an algorithm A, predicts a performance y of the algorithm A on an problem instance p without running the algorithm A. Generating the model M may include: defining a first set of features \vec{v}ᵢ for a set of training problem instances pᵢ; encoding a set of training algorithms Aⱼ in a second set of features \vec{u}ᵢ, wherein the set of training algorithms Aⱼ does not include the algorithm A; generating a set of training data (y_{m,n}, \vec{u}ₘ, \vec{v}ₙ) by computing a set of performance metrics y_{m,n} where y_{m,n} depends on data generated from algorithm Aₘ solving problem instance pₙ; and using supervised learning to train the model M based on the set of training data such that y_{m,n}≈M(\vec{u}ₘ, \vec{v}ₙ).

The method may further include predicting the performance y of algorithm A. The predicting may include: defining a problem feature vector \vec{v} for the problem instance p; encoding the algorithm A in an algorithm feature vector \vec{u}; and computing the performance of algorithm A according to y=M(\vec{u}, \vec{v}), without running the algorithm A. The method may further include using the model M to predict the performance of an algorithm B. The algorithm B may be an algorithm other than the algorithm A. For example, the algorithms A and B may have different features, such that if the algorithm B is encoded in a feature vector, that feature vector is different than the in an algorithm feature vector \vec{u} in which the algorithm A is encoded.

The second set of features \vec{u}ⱼ may include hyper-parameters of the algorithm Aⱼ. The second set of features \vec{u}ⱼ may include an indicator of performance of the algorithm Aⱼ on representative problem instances. The second set of features \vec{u}ⱼ may include properties of the outputs of the algorithm Aⱼ. A benchmarking testbed may supply information for the second set of features \vec{u}ⱼ.

A 1D Fermi-Hubbard model may be used as an application benchmark for gauging an ability of the algorithm A to handle strongly correlated fermionic problems.

The system may further include a quantum computer. The quantum computer may include a quantum component having a plurality of qubits. The quantum component may accept a sequence of instructions to evolve a quantum state based on a series of quantum gates. The algorithm A may be a quantum algorithm. The quantum algorithm A may produce a quantum state |ψ [symbol] as its output. The quantum state |ψ [symbol] may overlap with another quantum state |ϕ [symbol] . Defining the first set of features \vec{v}ᵢ may include using domain knowledge about the application instances, provided by domain specialists, to define the first set of features \vec{v}ᵢ.

Another embodiment is directed to a method, performed on a computer system, for generating a performance estimator model. The computer system includes a classical processor, a non-transitory computer-readable medium, and computer instructions stored in the non-transitory computer-readable medium. The computer instructions, when executed by the classical processor, perform the method. The method may include: receiving a set of problem instances for a given algorithm; defining a set of features for a set of problem instances; and using machine learning to train an empirical hardness model using the set of features, thereby generating the performance estimator model. The empirical hardness model may be adapted to generate a performance measurement representing performance of an input algorithm without running the input algorithm. The input algorithm may differ from the given algorithm. The performance measurement may be for algorithm runtime.

The method may further include using the performance estimator model to estimate the performance of an algorithm other than the given algorithm. The algorithm other than the given algorithm may include a quantum algorithm. The given algorithm may include a quantum algorithm.

The method may further include, at the performance estimator model: receiving an algorithm and a set a set of problem instances as input; and generating a model as output.

Another embodiment is directed to a system comprising a non-transitory computer-readable medium having computer instructions stored thereon. The computer instructions may be executable by a classical processor to perform a method for generating a performance estimator model. The method may include: receiving a set of problem instances for a given algorithm; defining a set of features for a set of problem instances; and using machine learning to train an empirical hardness model using the set of features, thereby generating the performance estimator model. The empirical hardness model may be adapted to generate a performance measurement representing performance of an input algorithm without running the input algorithm. The input algorithm may differ from the given algorithm. The performance measurement may be for algorithm runtime.

The method may further include using the performance estimator model to estimate the performance of an algorithm other than the given algorithm. The algorithm other than the given algorithm may include a quantum algorithm. The given algorithm may include a quantum algorithm.

The method may further include, at the performance estimator model: receiving an algorithm and a set a set of problem instances as input; and generating a model as output.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Various physical embodiments of a quantum computer are suitable for use according to the present disclosure. In general, the fundamental data storage unit in quantum computing is the quantum bit, or qubit. The qubit is a quantum-computing analog of a classical digital computer system bit. A classical bit is considered to occupy, at any given point in time, one of two possible states corresponding to the binary digits (bits) 0 or 1. By contrast, a qubit is implemented in hardware by a physical medium with quantum-mechanical characteristics. Such a medium, which physically instantiates a qubit, may be referred to herein as a “physical instantiation of a qubit,” a “physical embodiment of a qubit,” a “medium embodying a qubit,” or similar terms, or simply as a “qubit,” for ease of explanation. It should be understood, therefore, that references herein to “qubits” within descriptions of embodiments of the present invention refer to physical media which embody qubits.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement. A qubit, which has a quantum state of dimension two (i.e., has two orthogonal basis states), may be generalized to a d-dimensional “qudit,” where d may be any integral value, such as 2, 3, 4, or higher. In the general case of a qudit, measurement of the qudit produces one of d different basis states resolved from the state of the qudit. Any reference herein to a qubit should be understood to refer more generally to an d-dimensional qudit with any value of d.

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, if electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred to as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2×2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. (As is well-known to those having ordinary skill in the art, a Hilbert space is an abstract vector space possessing the structure of an inner product that allows length and angle to be measured. Furthermore, Hilbert spaces are complete: there are enough limits in the space to allow the techniques of calculus to be used.)

A quantum circuit may be specified as a sequence of quantum gates. As described in more detail below, the term “quantum gate,” as used herein, refers to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2ⁿ×2ⁿ complex matrix representing the same overall state change on n qubits. A quantum circuit may thus be expressed as a single resultant operator. However, designing a quantum circuit in terms of constituent gates allows the design to conform to a standard set of gates, and thus enable greater ease of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Some embodiments described herein generate, measure, or utilize quantum states that approximate a target quantum state (e.g., a ground state of a Hamiltonian). As will be appreciated by those trained in the art, there are many ways to quantify how well a first quantum state “approximates” a second quantum state. In the following description, any concept or definition of approximation known in the art may be used without departing from the scope hereof. For example, when the first and second quantum states are represented as first and second vectors, respectively, the first quantum state approximates the second quantum state when an inner product between the first and second vectors (called the “fidelity” between the two quantum states) is greater than a predefined amount (typically labeled ϵ). In this example, the fidelity quantifies how “close” or “similar” the first and second quantum states are to each other. The fidelity represents a probability that a measurement of the first quantum state will give the same result as if the measurement were performed on the second quantum state. Proximity between quantum states can also be quantified with a distance measure, such as a Euclidean norm, a Hamming distance, or another type of norm known in the art. Proximity between quantum states can also be defined in computational terms. For example, the first quantum state approximates the second quantum state when a polynomial time-sampling of the first quantum state gives some desired information or property that it shares with the second quantum state.

Not all quantum computers are gate model quantum computers. Embodiments of the present invention are not limited to being implemented using gate model quantum computers. As an alternative example, embodiments of the present invention may be implemented, in whole or in part, using a quantum computer that is implemented using a quantum annealing architecture, which is an alternative to the gate model quantum computing architecture. More specifically, quantum annealing (QA) is a metaheuristic for finding the global minimum of a given objective function over a given set of candidate solutions (candidate states), by a process using quantum fluctuations.

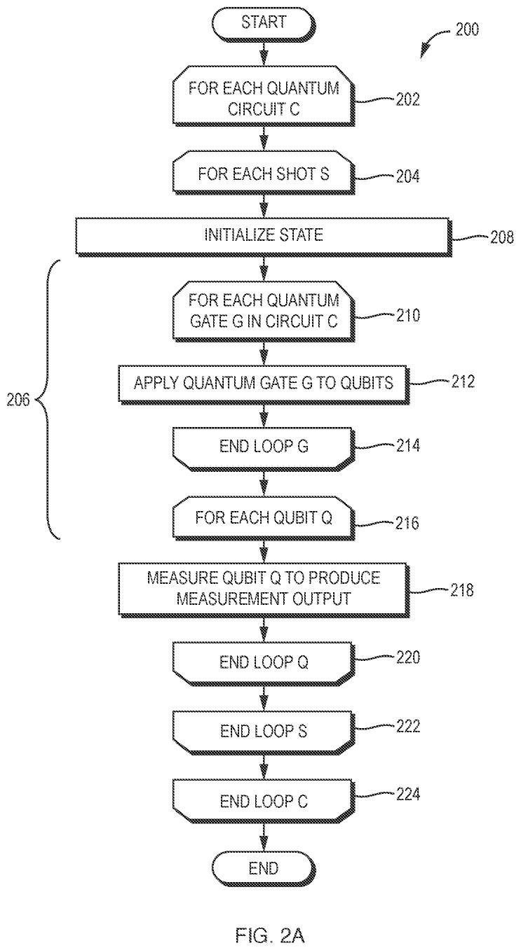

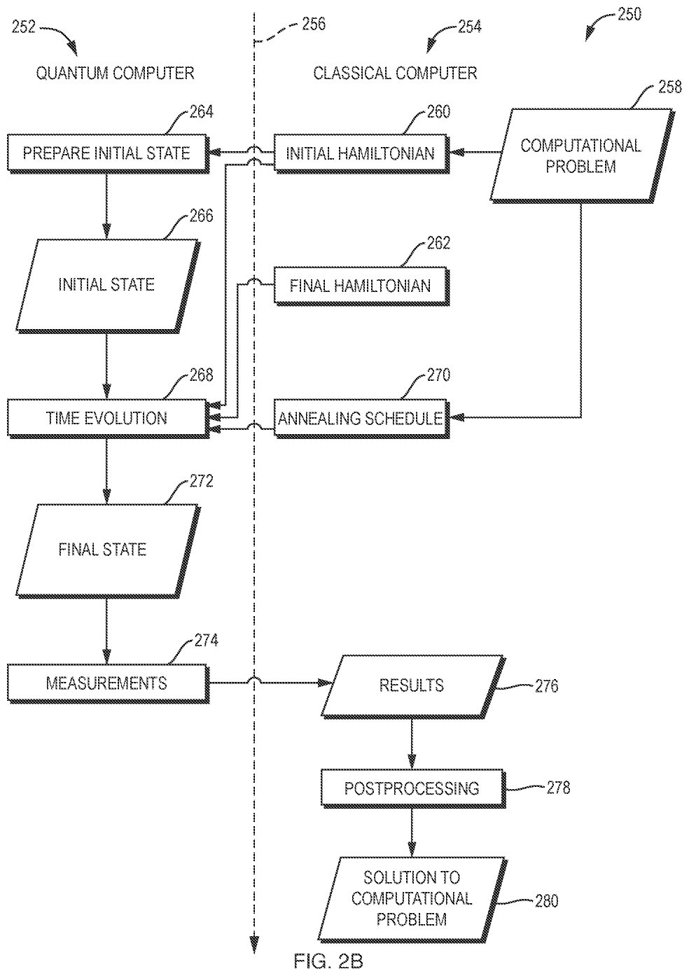

FIG. 2B shows a diagram illustrating operations typically performed by a computer system 250 which implements quantum annealing. The system 250 includes both a quantum computer 252 and a classical computer 254. Operations shown on the left of the dashed vertical line 256 typically are performed by the quantum computer 252, while operations shown on the right of the dashed vertical line 256 typically are performed by the classical computer 254.

Quantum annealing starts with the classical computer 254 generating an initial Hamiltonian 260 and a final Hamiltonian 262 based on a computational problem 258 to be solved, and providing the initial Hamiltonian 260, the final Hamiltonian 262 and an annealing schedule 270 as input to the quantum computer 252. The quantum computer 252 prepares a well-known initial state 266 (FIG. 2B, operation 264), such as a quantum-mechanical superposition of all possible states (candidate states) with equal weights, based on the initial Hamiltonian 260. The classical computer 254 provides the initial Hamiltonian 260, a final Hamiltonian 262, and an annealing schedule 270 to the quantum computer 252. The quantum computer 252 starts in the initial state 266, and evolves its state according to the annealing schedule 270 following the time-dependent Schrodinger equation, a natural quantum-mechanical evolution of physical systems (FIG. 2B, operation 268). More specifically, the state of the quantum computer 252 undergoes time evolution under a time-dependent Hamiltonian, which starts from the initial Hamiltonian 260 and terminates at the final Hamiltonian 262. If the rate of change of the system Hamiltonian is slow enough, the system stays close to the ground state of the instantaneous Hamiltonian. If the rate of change of the system Hamiltonian is accelerated, the system may leave the ground state temporarily but produce a higher likelihood of concluding in the ground state of the final problem Hamiltonian, i.e., diabatic quantum computation. At the end of the time evolution, the set of qubits on the quantum annealer is in a final state 272, which is expected to be close to the ground state of the classical Ising model that corresponds to the solution to the original computational problem 258. An experimental demonstration of the success of quantum annealing for random magnets was reported immediately after the initial theoretical proposal.

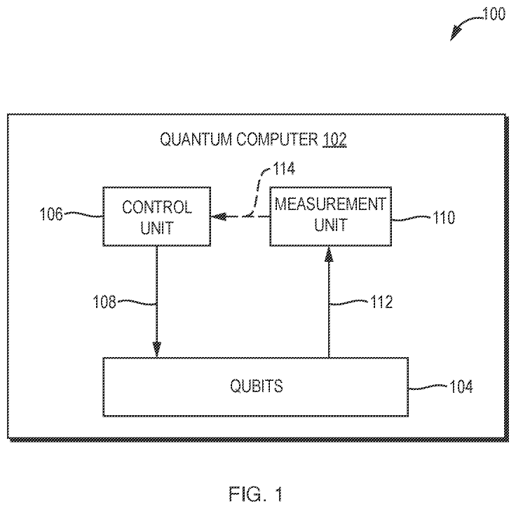

The final state 272 of the quantum computer 252 is measured, thereby producing results 276 (i.e., measurements) (FIG. 2B, operation 274). The measurement operation 274 may be performed, for example, in any of the ways disclosed herein, such as in any of the ways disclosed herein in connection with the measurement unit 110 in FIG. 1. The classical computer 254 performs postprocessing on the measurement results 276 to produce output 280 representing a solution to the original computational problem 258 (FIG. 2B, operation 278).

As yet another alternative example, embodiments of the present invention may be implemented, in whole or in part, using a quantum computer that is implemented using a one-way quantum computing architecture, also referred to as a measurement-based quantum computing architecture, which is another alternative to the gate model quantum computing architecture. More specifically, the one-way or measurement based quantum computer (MBQC) is a method of quantum computing that first prepares an entangled resource state, usually a cluster state or graph state, then performs single qubit measurements on it. It is “one-way” because the resource state is destroyed by the measurements.

The outcome of each individual measurement is random, but they are related in such a way that the computation always succeeds. In general the choices of basis for later measurements need to depend on the results of earlier measurements, and hence the measurements cannot all be performed at the same time.

Any of the functions disclosed herein may be implemented using means for performing those functions. Such means include, but are not limited to, any of the components disclosed herein, such as the computer-related components described below.

Referring to FIG. 1, a diagram is shown of a system 100 implemented according to one embodiment of the present invention. Referring to FIG. 2A, a flowchart is shown of a method 200 performed by the system 100 of FIG. 1 according to one embodiment of the present invention. The system 100 includes a quantum computer 102. The quantum computer 102 includes a plurality of qubits 104, which may be implemented in any of the ways disclosed herein. There may be any number of qubits 104 in the quantum computer 102. For example, the qubits 104 may include or consist of no more than 2 qubits, no more than 4 qubits, no more than 8 qubits, no more than 16 qubits, no more than 32 qubits, no more than 64 qubits, no more than 128 qubits, no more than 256 qubits, no more than 512 qubits, no more than 1024 qubits, no more than 2048 qubits, no more than 4096 qubits, or no more than 8192 qubits. These are merely examples, in practice there may be any number of qubits 104 in the quantum computer 102.

There may be any number of gates in a quantum circuit. However, in some embodiments the number of gates may be at least proportional to the number of qubits 104 in the quantum computer 102. In some embodiments the gate depth may be no greater than the number of qubits 104 in the quantum computer 102, or no greater than some linear multiple of the number of qubits 104 in the quantum computer 102 (e.g., 2, 3, 4, 5, 6, or 7).

The qubits 104 may be interconnected in any graph pattern. For example, they be connected in a linear chain, a two-dimensional grid, an all-to-all connection, any combination thereof, or any subgraph of any of the preceding.

As will become clear from the description below, although element 102 is referred to herein as a “quantum computer,” this does not imply that all components of the quantum computer 102 leverage quantum phenomena. One or more components of the quantum computer 102 may, for example, be classical (i.e., non-quantum components) components which do not leverage quantum phenomena.

The quantum computer 102 includes a control unit 106, which may include any of a variety of circuitry and/or other machinery for performing the functions disclosed herein. The control unit 106 may, for example, consist entirely of classical components. The control unit 106 generates and provides as output one or more control signals 108 to the qubits 104. The control signals 108 may take any of a variety of forms, such as any kind of electromagnetic signals, such as electrical signals, magnetic signals, optical signals (e.g., laser pulses), or any combination thereof.

For example:

In embodiments in which some or all of the qubits 104 are implemented as photons (also referred to as a “quantum optical” implementation) that travel along waveguides, the control unit 106 may be a beam splitter (e.g., a heater or a mirror), the control signals 108 may be signals that control the heater or the rotation of the mirror, the measurement unit 110 may be a photodetector, and the measurement signals 112 may be photons.

In embodiments in which some or all of the qubits 104 are implemented as charge type qubits (e.g., transmon, X-mon, G-mon) or flux-type qubits (e.g., flux qubits, capacitively shunted flux qubits) (also referred to as a “circuit quantum electrodynamic” (circuit QED) implementation), the control unit 106 may be a bus resonator activated by a drive, the control signals 108 may be cavity modes, the measurement unit 110 may be a second resonator (e.g., a low-Q resonator), and the measurement signals 112 may be voltages measured from the second resonator using dispersive readout techniques.

In embodiments in which some or all of the qubits 104 are implemented as superconducting circuits, the control unit 106 may be a circuit QED-assisted control unit or a direct capacitive coupling control unit or an inductive capacitive coupling control unit, the control signals 108 may be cavity modes, the measurement unit 110 may be a second resonator (e.g., a low-Q resonator), and the measurement signals 112 may be voltages measured from the second resonator using dispersive readout techniques.

In embodiments in which some or all of the qubits 104 are implemented as trapped ions (e.g., electronic states of, e.g., magnesium ions), the control unit 106 may be a laser, the control signals 108 may be laser pulses, the measurement unit 110 may be a laser and either a CCD or a photodetector (e.g., a photomultiplier tube), and the measurement signals 112 may be photons.

In embodiments in which some or all of the qubits 104 are implemented using nuclear magnetic resonance (NMR) (in which case the qubits may be molecules, e.g., in liquid or solid form), the control unit 106 may be a radio frequency (RF) antenna, the control signals 108 may be RF fields emitted by the RF antenna, the measurement unit 110 may be another RF antenna, and the measurement signals 112 may be RF fields measured by the second RF antenna.

In embodiments in which some or all of the qubits 104 are implemented as nitrogen-vacancy centers (NV centers), the control unit 106 may, for example, be a laser, a microwave antenna, or a coil, the control signals 108 may be visible light, a microwave signal, or a constant electromagnetic field, the measurement unit 110 may be a photodetector, and the measurement signals 112 may be photons.

In embodiments in which some or all of the qubits 104 are implemented as two-dimensional quasiparticles called “anyons” (also referred to as a “topological quantum computer” implementation), the control unit 106 may be nanowires, the control signals 108 may be local electrical fields or microwave pulses, the measurement unit 110 may be superconducting circuits, and the measurement signals 112 may be voltages.

In embodiments in which some or all of the qubits 104 are implemented as semiconducting material (e.g., nanowires), the control unit 106 may be microfabricated gates, the control signals 108 may be RF or microwave signals, the measurement unit 110 may be microfabricated gates, and the measurement signals 112 may be RF or microwave signals.

Although not shown explicitly in FIG. 1 and not required, the measurement unit 110 may provide one or more feedback signals 114 to the control unit 106 based on the measurement signals 112. For example, quantum computers referred to as “one-way quantum computers” or “measurement-based quantum computers” utilize such feedback signals 114 from the measurement unit 110 to the control unit 106. Such feedback signals 114 are also necessary for the operation of fault-tolerant quantum computing and error correction.

The control signals 108 may, for example, include one or more state preparation signals which, when received by the qubits 104, cause some or all of the qubits 104 to change their states. Such state preparation signals constitute a quantum circuit also referred to as an “ansatz circuit.” The resulting state of the qubits 104 is referred to herein as an “initial state” or an “ansatz state.” The process of outputting the state preparation signal(s) to cause the qubits 104 to be in their initial state is referred to herein as “state preparation” (FIG. 2A, section 206). A special case of state preparation is “initialization,” also referred to as a “reset operation,” in which the initial state is one in which some or all of the qubits 104 are in the “zero” state i.e. the default single-qubit state. More generally, state preparation may involve using the state preparation signals to cause some or all of the qubits 104 to be in any distribution of desired states. In some embodiments, the control unit 106 may first perform initialization on the qubits 104 and then perform preparation on the qubits 104, by first outputting a first set of state preparation signals to initialize the qubits 104, and by then outputting a second set of state preparation signals to put the qubits 104 partially or entirely into non-zero states.

Another example of control signals 108 that may be output by the control unit 106 and received by the qubits 104 are gate control signals. The control unit 106 may output such gate control signals, thereby applying one or more gates to the qubits 104. Applying a gate to one or more qubits causes the set of qubits to undergo a physical state change which embodies a corresponding logical gate operation (e.g., single-qubit rotation, two-qubit entangling gate or multi-qubit operation) specified by the received gate control signal. As this implies, in response to receiving the gate control signals, the qubits 104 undergo physical transformations which cause the qubits 104 to change state in such a way that the states of the qubits 104, when measured (see below), represent the results of performing logical gate operations specified by the gate control signals. The term “quantum gate,” as used herein, refers to the application of a gate control signal to one or more qubits to cause those qubits to undergo the physical transformations described above and thereby to implement a logical gate operation.

It should be understood that the dividing line between state preparation (and the corresponding state preparation signals) and the application of gates (and the corresponding gate control signals) may be chosen arbitrarily. For example, some or all the components and operations that are illustrated in FIGS. 1 and 2A-2B as elements of “state preparation” may instead be characterized as elements of gate application. Conversely, for example, some or all of the components and operations that are illustrated in FIGS. 1 and 2A-2B as elements of “gate application” may instead be characterized as elements of state preparation. As one particular example, the system and method of FIGS. 1 and 2A-2B may be characterized as solely performing state preparation followed by measurement, without any gate application, where the elements that are described herein as being part of gate application are instead considered to be part of state preparation. Conversely, for example, the system and method of FIGS. 1 and 2A-2B may be characterized as solely performing gate application followed by measurement, without any state preparation, and where the elements that are described herein as being part of state preparation are instead considered to be part of gate application.

The quantum computer 102 also includes a measurement unit 110, which performs one or more measurement operations on the qubits 104 to read out measurement signals 112 (also referred to herein as “measurement results”) from the qubits 104, where the measurement results 112 are signals representing the states of some or all of the qubits 104. In practice, the control unit 106 and the measurement unit 110 may be entirely distinct from each other, or contain some components in common with each other, or be implemented using a single unit (i.e., a single unit may implement both the control unit 106 and the measurement unit 110). For example, a laser unit may be used both to generate the control signals 108 and to provide stimulus (e.g., one or more laser beams) to the qubits 104 to cause the measurement signals 112 to be generated.

In general, the quantum computer 102 may perform various operations described above any number of times. For example, the control unit 106 may generate one or more control signals 108, thereby causing the qubits 104 to perform one or more quantum gate operations. The measurement unit 110 may then perform one or more measurement operations on the qubits 104 to read out a set of one or more measurement signals 112. The measurement unit 110 may repeat such measurement operations on the qubits 104 before the control unit 106 generates additional control signals 108, thereby causing the measurement unit 110 to read out additional measurement signals 112 resulting from the same gate operations that were performed before reading out the previous measurement signals 112. The measurement unit 110 may repeat this process any number of times to generate any number of measurement signals 112 corresponding to the same gate operations. The quantum computer 102 may then aggregate such multiple measurements of the same gate operations in any of a variety of ways.

After the measurement unit 110 has performed one or more measurement operations on the qubits 104 after they have performed one set of gate operations, the control unit 106 may generate one or more additional control signals 108, which may differ from the previous control signals 108, thereby causing the qubits 104 to perform one or more additional quantum gate operations, which may differ from the previous set of quantum gate operations. The process described above may then be repeated, with the measurement unit 110 performing one or more measurement operations on the qubits 104 in their new states (resulting from the most recently-performed gate operations).

In general, the system 100 may implement a plurality of quantum circuits as follows. For each quantum circuit C in the plurality of quantum circuits (FIG. 2A, operation 202), the system 100 performs a plurality of “shots” on the qubits 104. The meaning of a shot will become clear from the description that follows. For each shot S in the plurality of shots (FIG. 2A, operation 204), the system 100 prepares the state of the qubits 104 (FIG. 2A, section 206). More specifically, for each quantum gate Gin quantum circuit C (FIG. 2A, operation 210), the system 100 applies quantum gate G to the qubits 104 (FIG. 2A, operations 212 and 214).

Then, for each of the qubits Q 104 (FIG. 2A, operation 216), the system 100 measures the qubit Q to produce measurement output representing a current state of qubit Q (FIG. 2A, operations 218 and 220).

The operations described above are repeated for each shot S (FIG. 2A, operation 222), and circuit C (FIG. 2A, operation 224). As the description above implies, a single “shot” involves preparing the state of the qubits 104 and applying all of the quantum gates in a circuit to the qubits 104 and then measuring the states of the qubits 104; and the system 100 may perform multiple shots for one or more circuits.

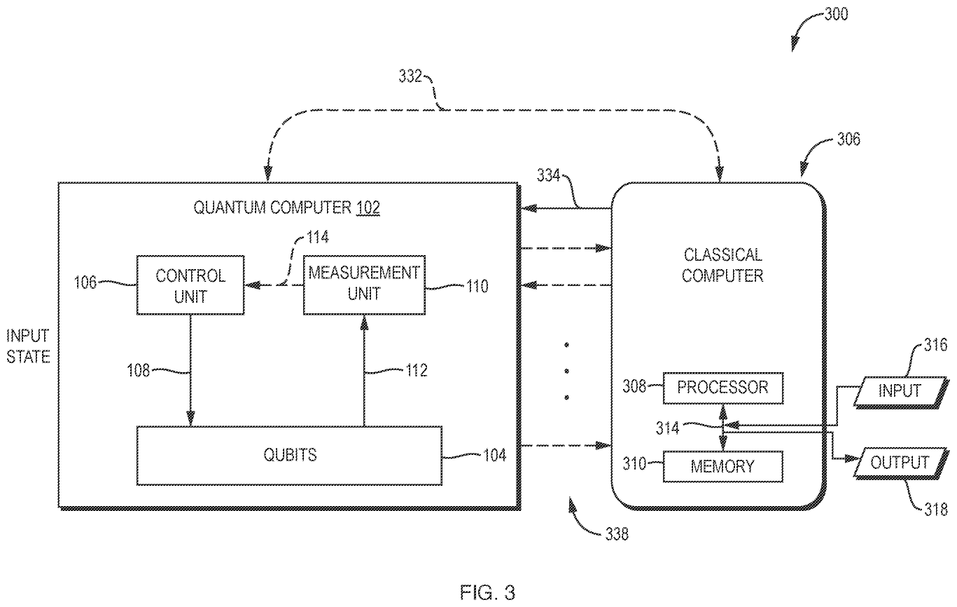

Referring to FIG. 3, a diagram is shown of a hybrid quantum classical (HQC) computer 300 implemented according to one embodiment of the present invention. The HQC 300 includes a quantum computer component 102 (which may, for example, be implemented in the manner shown and described in connection with FIG. 1) and a classical computer component 306. The classical computer component may be a machine implemented according to the general computing model established by John Von Neumann, in which programs are written in the form of ordered lists of instructions and stored within a classical (e.g., digital) memory 310 and executed by a classical (e.g., digital) processor 308 of the classical computer. The memory 310 is classical in the sense that it stores data in a storage medium in the form of bits, which have a single definite binary state at any point in time. The bits stored in the memory 310 may, for example, represent a computer program. The classical computer component 304 typically includes a bus 314. The processor 308 may read bits from and write bits to the memory 310 over the bus 314. For example, the processor 308 may read instructions from the computer program in the memory 310, and may optionally receive input data 316 from a source external to the computer 302, such as from a user input device such as a mouse, keyboard, or any other input device. The processor 308 may use instructions that have been read from the memory 310 to perform computations on data read from the memory 310 and/or the input 316, and generate output from those instructions. The processor 308 may store that output back into the memory 310 and/or provide the output externally as output data 318 via an output device, such as a monitor, speaker, or network device.

The quantum computer component 102 may include a plurality of qubits 104, as described above in connection with FIG. 1. A single qubit may represent a one, a zero, or any quantum superposition of those two qubit states. The classical computer component 304 may provide classical state preparation signals 332 to the quantum computer 102, in response to which the quantum computer 102 may prepare the states of the qubits 104 in any of the ways disclosed herein, such as in any of the ways disclosed in connection with FIGS. 1 and 2A-2B.

Once the qubits 104 have been prepared, the classical processor 308 may provide classical control signals 334 to the quantum computer 102, in response to which the quantum computer 102 may apply the gate operations specified by the control signals 332 to the qubits 104, as a result of which the qubits 104 arrive at a final state. The measurement unit 110 in the quantum computer 102 (which may be implemented as described above in connection with FIGS. 1 and 2A-2B) may measure the states of the qubits 104 and produce measurement output 338 representing the collapse of the states of the qubits 104 into one of their eigenstates. As a result, the measurement output 338 includes or consists of bits and therefore represents a classical state. The quantum computer 102 provides the measurement output 338 to the classical processor 308. The classical processor 308 may store data representing the measurement output 338 and/or data derived therefrom in the classical memory 310.

The steps described above may be repeated any number of times, with what is described above as the final state of the qubits 104 serving as the initial state of the next iteration. In this way, the classical computer 304 and the quantum computer 102 may cooperate as co-processors to perform joint computations as a single computer system.

Although certain functions may be described herein as being performed by a classical computer and other functions may be described herein as being performed by a quantum computer, these are merely examples and do not constitute limitations of the present invention. A subset of the functions which are disclosed herein as being performed by a quantum computer may instead be performed by a classical computer. For example, a classical computer may execute functionality for emulating a quantum computer and provide a subset of the functionality described herein, albeit with functionality limited by the exponential scaling of the simulation. Functions which are disclosed herein as being performed by a classical computer may instead be performed by a quantum computer.

The techniques described above may be implemented, for example, in hardware, in one or more computer programs tangibly stored on one or more computer-readable media, firmware, or any combination thereof, such as solely on a quantum computer, solely on a classical computer, or on a hybrid quantum classical (HQC) computer. The techniques disclosed herein may, for example, be implemented solely on a classical computer, in which the classical computer emulates the quantum computer functions disclosed herein.

Any reference herein to the state |0 [symbol] may alternatively refer to the state |1 [symbol] , and vice versa. In other words, any role described herein for the states |0 [symbol] and |1 [symbol] may be reversed within embodiments of the present invention. More generally, any computational basis state disclosed herein may be replaced with any suitable reference state within embodiments of the present invention.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention apply a trained model to a quantum algorithm to generate an estimate of the performance of that algorithm. A hybrid quantum-classical computer may be used to generate such an estimate. Such a feature cannot be performed mentally or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method, performed on a computer system, for modeling the relative performance of algorithms over a set of problem instances, the computer system comprising a classical processor, a non-transitory computer-readable medium, and computer instructions stored in the non-transitory computer-readable medium, wherein the computer instructions, when executed by the classical processor, perform the method, the method comprising:
generating a model M that, when applied to an algorithm A, predicts a performance y of the algorithm A on an problem instance p without running the algorithm A, wherein generating the model M comprises:
defining a first set of features \vec{v}ᵢ for a set of training problem instances pᵢ;
encoding a set of training algorithms Aⱼ in a second set of features \vec{u}ⱼ, wherein the set of training algorithms Aⱼ does not include the algorithm A;
generating a set of training data (y_{m,n}, \vec{u}ₘ, \vec{v}ₙ) by computing a set of performance metrics y_{m,n} where y_{m,n} depends on data generated from algorithm Aₘ solving problem instance pₙ; and
using supervised learning to train the model M based on the set of training data such that y_{m,n}≈M(\vec{u}ₘ, \vec{v}ₙ).

2. The method of claim 1, further comprising predicting the performance y of algorithm A, the predicting comprising:
defining a problem feature vector \vec{v} for the problem instance p;
encoding the algorithm A in an algorithm feature vector \vec{u}; and
computing the performance of algorithm A according to y=M(\vec{u}, \vec{v}), without running the algorithm A.

3. The method of claim 2, further including using the model M to predict the performance of an algorithm B, other than the algorithm A.

4. The method of claim 1, wherein \vec{u}ⱼ includes hyper-parameters of the algorithm Aⱼ.

5. The method of claim 1, wherein \vec{u}ⱼ includes an indicator of performance of the algorithm Aⱼ on representative problem instances.

6. The method of claim 1, wherein a 1D Fermi-Hubbard model is used as an application benchmark for gauging an ability of the algorithm A to handle strongly correlated fermionic problems.

7. The method of claim 1, wherein \vec{u}ⱼ includes properties of the outputs of the algorithm Aⱼ.

8. The method of claim 1, wherein a benchmarking testbed supplies information for the second set of features \vec{u}ⱼ.

9. The method of claim 1, wherein the computer system further comprises a quantum computer, the quantum computer including a quantum component, having a plurality of qubits, which accepts a sequence of instructions to evolve a quantum state based on a series of quantum gates;
wherein the algorithm A comprises a quantum algorithm.

10. The method of claim 9, wherein the quantum algorithm A produces a quantum state |ψ [symbol] as its output.

11. The method of claim 10, wherein the quantum state |ψ [symbol] overlaps with another quantum state |ϕ [symbol] .

12. The method of claim 9, wherein defining the first set of features \vec{v}ᵢ comprises using domain knowledge about the application instances, provided by domain specialists, to define the first set of features \vec{v}ᵢ.

13. A system comprising a non-transitory computer-readable medium having computer instructions stored thereon, the computer instructions being executable by a classical processor to perform a method for modeling the relative performance of algorithms over a set of problem instances, the method comprising:
generating a model M that, when applied to an algorithm A, predicts a performance y of the algorithm A on an problem instance p without running the algorithm A, wherein generating the model M comprises:
defining a first set of features \vec{v}ᵢ for a set of training problem instances pᵢ;
encoding a set of training algorithms Aⱼ in a second set of features \vec{u}ⱼ, wherein the set of training algorithms Aⱼ does not include the algorithm A;
generating a set of training data (y_{m,n}, \vec{u}ₘ, \vec{v}ₙ) by computing a set of performance metrics y_{m,n} where y_{m,n} depends on data generated from algorithm Aₘ solving problem instance pₙ; and
using supervised learning to train the model M based on the set of training data such that y_{m,n}≈M(\vec{u}ₘ, \vec{v}ₙ).

14. The system of claim 13, wherein the method further comprises predicting the performance y of algorithm A, the predicting comprising:
defining a problem feature vector \vec{v} for the problem instance p;
encoding the algorithm A in an algorithm feature vector \vec{u}; and
computing the performance of algorithm A according to y=M (\vec{u}, \vec{v}), without running the algorithm A.

15. The system of claim 14, wherein the method further comprises using the model M to predict the performance of an algorithm B, other than the algorithm A.

16. The system of claim 13, wherein \vec{u}ⱼ includes hyper-parameters of the algorithm Aⱼ.

17. The system of claim 13, wherein \vec{u}ⱼ includes an indicator of performance of the algorithm Aⱼ on representative problem instances.

18. The system of claim 13, wherein a 1D Fermi-Hubbard model is used as an application benchmark for gauging an ability of the algorithm A to handle strongly correlated fermionic problems.

19. The system of claim 13, wherein \vec{u}ⱼ includes properties of the outputs of the algorithm Aⱼ.

20. The system of claim 13, wherein a benchmarking testbed supplies information for the second set of features \vec{u}ⱼ.

21. The system of claim 13, further comprising:
a quantum computer, the quantum computer including a quantum component, having a plurality of qubits, which accepts a sequence of instructions to evolve a quantum state based on a series of quantum gates;
wherein the algorithm A comprises a quantum algorithm.

22. The system of claim 21, wherein the quantum algorithm A produces a quantum state |ψ [symbol] as its output.

23. The system of claim 22, wherein the quantum state |ψ [symbol] overlaps with another quantum state |ϕ [symbol] .

24. The system of claim 21, wherein defining the first set of features \vec{v}ᵢ comprises using domain knowledge about the application instances, provided by domain specialists, to define the first set of features \vec{v}ᵢ.

25. A method, performed on a computer system, for generating a performance estimator model, the computer system comprising a classical processor, a non-transitory computer-readable medium, and computer instructions stored in the non-transitory computer-readable medium, wherein the computer instructions, when executed by the classical processor, perform the method, the method comprising:
receiving a set of problem instances for a given algorithm;
defining a set of features for a set of problem instances; and
using machine learning to train an empirical hardness model using the set of features, wherein the empirical hardness model is adapted to generate a performance measurement representing performance of an input algorithm without running the input algorithm, wherein the input algorithm differs from the given algorithm, thereby generating the performance estimator model.

26. The method of claim 25, wherein the performance measurement is for algorithm runtime.

27. The method of claim 25, further comprising using the performance estimator model to estimate the performance of an algorithm other than the given algorithm.

28. The method of claim 27, wherein the algorithm other than the given algorithm comprises a quantum algorithm.

29. The method of claim 25, wherein the given algorithm comprises a quantum algorithm.

30. The method of claim 25, further comprising, at the performance estimator model:
receiving an algorithm and a set a set of problem instances as input; and
generating a model as output.

31. A system comprising a non-transitory computer-readable medium having computer instructions stored thereon, the computer instructions being executable by a classical processor to perform a method for generating a performance estimator model, the method comprising:
receiving a set of problem instances for a given algorithm;
defining a set of features for a set of problem instances; and
using machine learning to train an empirical hardness model using the set of features, wherein the empirical hardness model is adapted to generate a performance measurement representing performance of an input algorithm without running the input algorithm, wherein the input algorithm differs from the given algorithm, thereby generating the performance estimator model.

32. The system of claim 31, wherein the performance measurement is for algorithm runtime.

33. The system of claim 31, wherein the method further comprises using the performance estimator model to estimate the performance of an algorithm other than the given algorithm.

34. The system of claim 33, wherein the algorithm other than the given algorithm comprises a quantum algorithm.

35. The system of claim 31, wherein the given algorithm comprises a quantum algorithm.

36. The system of claim 31, wherein the performance estimator model is adapted to receive an algorithm and a set a set of problem instances as input; and generate a model as output.
